(19) United States
(12) Patent Application Publication
(10) Pub. No.: US 2017/0152942 A1
(43) Pub. Date: Jun. 1, 2017

(54) ROTARY ELECTRIC DEVICE AND SHIFT-BY-WIRE SYSTEM HAVING THE SAME

(71) Applicant: DENSO CORPORATION, Kariya-city (JP)

(72) Inventor: Takanori MAKINO, Kariya-city (JP)

(21) Appl. No.: 15/351,835

(22) Filed: Nov. 15, 2016

(30) Foreign Application Priority Data
Nov. 26, 2015 (JP) 2015-230337

(51) Int. Cl. F16H 61/32; H02K 1/14; H02K 11/30; H02K 1/24

(52) U.S. Cl. CPC F16H 61/32; H02K 1/24; H02K 1/146; H02K 11/30; F16H 2061/326

(57) ABSTRACT

A stator is equipped in a housing. A coil is equipped to the stator to produce a magnetic flux when supplied with an electricity. A rotor is formed of a magnetic material and is rotational in the stator. The rotor includes a rotor core, a salient pole, and an accommodation cavity portion. The salient pole is projected from the rotor core toward the stator. The accommodation cavity portion extends in the salient pole along the thickness direction. An expansive member is formed of a magnetic material, which has a thermal expansion coefficient different from a thermal expansion coefficient of the rotor. The expansive member is equipped in the accommodation cavity portion. The expansive member expands in response to increase in a temperature.

### CROSS REFERENCE TO RELATED APPLICATION

This application is based on Japanese Patent Application No. 2015-230337 filed on Nov. 26, 2015, the disclosure of which is incorporated herein by reference.

### TECHNICAL FIELD

The present disclosure relates to a rotary electric device configured to output a torque. The present disclosure further relates to a shift-by-wire system including the rotary electric device.

### BACKGROUND

Conventionally, a shift-by-wire system is known as a shift range switching device for an automobile. The shift-by-wire system is configured to cause an electronic control unit to detect a shift range, which is selected by a driver for an automatic transmission, and to control a driving power of a rotary driving device according to the detection value, thereby to switch the shift range.

(Patent Literature 1)

Japanese published unexamined application No. 2013-247798

The shift-by-wire system of Patent Literature 1 includes a rotary driving device having an output portion, which is connected to a shift range switching device of an automatic transmission device. The rotary driving device includes a rotary electric device. The rotary electric device outputs a torque (output torque), and the torque is output from the output portion via reduction gears. The output torque from the rotary electric device is in proportion to a magnetic flux produced from a coil. The magnetic flux from the coil is in proportion to an electric current, which flows into the coil. In general, a shift-by-wire system is used under a wide temperature range between, for example, −40 degree Celsius to 100 degree Celsius. The resistance of the coil varies as the environmental temperature varies. Specifically, the resistance of the coil becomes higher as the environmental temperature becomes higher. In consideration of that, a magnetic flux produced from the coil may become unstable because of the tendency of the resistance of the coil. More specifically, the output torque from the rotary electric device may become greater under a low temperature state, and the output torque may become smaller under a high temperature state. For the above reasons, the output torque of a rotary electric device may become unstable due to variation in the environmental temperature.

### SUMMARY

It is an object of the present disclosure to produce a rotary electric device configured to produce an output torque substantially stable with respect to variation in the environmental temperature. It is an object of the present disclosure to produce a shift-by-wire system including the rotary electric device.

According to an aspect of the present disclosure, a rotary electric device comprises a housing. The rotary electric device further comprises a stator equipped in the housing. The rotary electric device further comprises a coil equipped to the stator and configured to produce a magnetic flux when supplied with an electricity. The rotary electric device further comprises a rotor formed of a magnetic material and rotational in the stator. The rotor includes a rotor core, a salient pole, and an accommodation cavity portion. The salient pole is projected from the rotor core toward the stator. The accommodation cavity portion extends in the salient pole along a thickness direction. The rotary electric device further comprises an expansive member formed of a magnetic material, which has a thermal expansion coefficient different from a thermal expansion coefficient of the rotor. The expansive member is equipped in the accommodation cavity portion. The expansive member is configured to expand in response to increase in a temperature.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing a rotary driving device including a rotary electric device according to a first embodiment of the present disclosure;

FIG. 2 is a schematic view showing a shift-by-wire system employing the rotary driving device including the rotary electric device according to the first embodiment of the present disclosure;

FIG. 3 is a rear view showing a portion of the shift-by-wire system, without a rear cover portion, according to the first embodiment of the present disclosure, the rear view viewed along an arrow III in FIG. 1;

FIG. 4A is a sectional view showing an expansive member and a portion of the rotary electric device around the expansive member according to the first embodiment of the present disclosure in a state where an environmental temperature is below a predetermined temperature, and FIG. 4B is a sectional view showing the expansive member and the portion of the rotary electric device in a state where the environmental temperature is higher than the predetermined temperature; and

FIG. 5A is a sectional view taken along a line VA-VA in FIG. 4A, and FIG. 5B is a sectional view taken along a line VB-VB in FIG. 4B.

### DETAILED DESCRIPTION

As follows, a rotary driving device including a rotary electric device according to a first embodiment of the present disclosure will be described with reference to drawings.

### First Embodiment

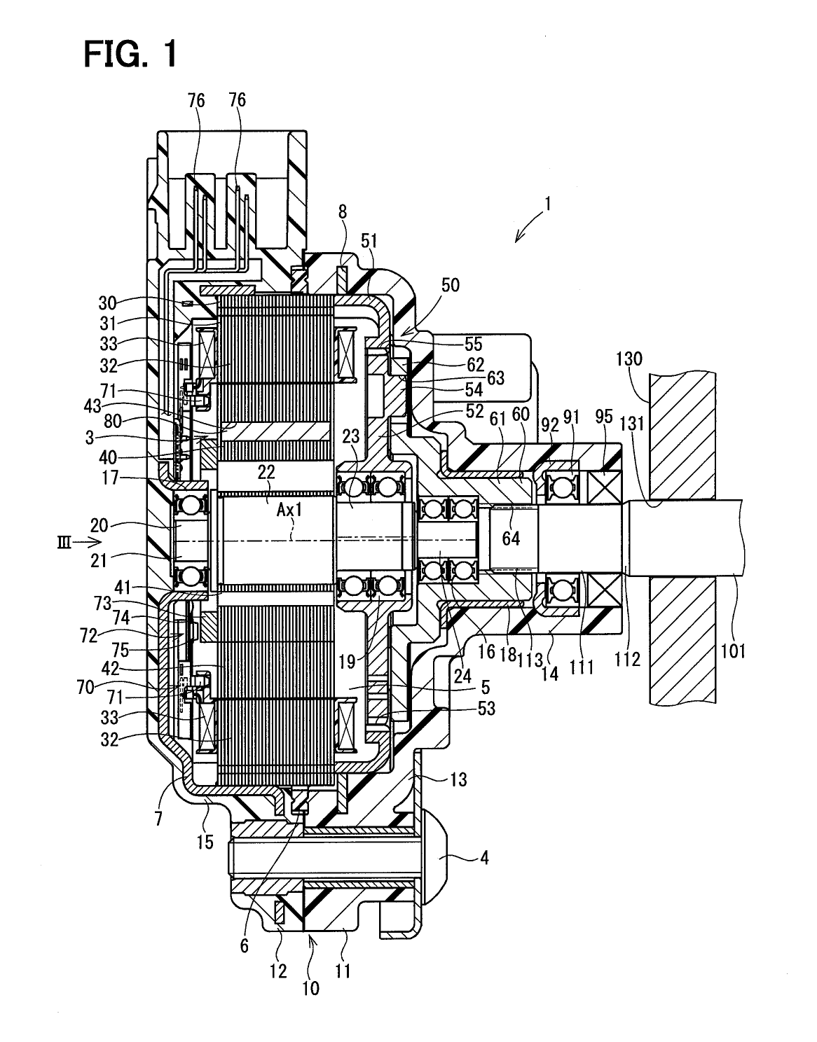

As shown in FIG. 1, a rotary actuator 1 as a rotary driving device is employed as, for example, a driving unit for a shift-by-wire system to switch a shift range of a vehicle.

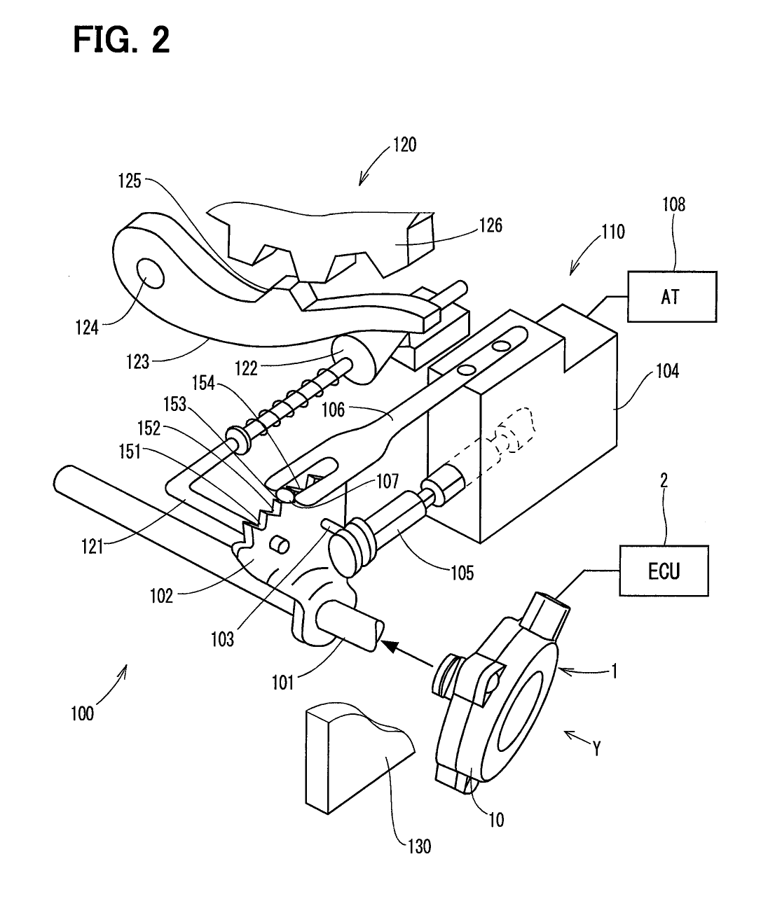

First, the shift-by-wire system will be described. As shown in FIG. 2, a shift-by-wire system 100 includes the rotary actuator 1, an electronically controlled unit (as follows, referred to as ECU) 2, a shift range switching device 110, a parking switching device 120, and the like. The rotary actuator 1 rotates a manual shaft 101 of the shift range switching device 110 as a driven object. The present configuration enables to switch a shift range of an automatic transmission device 108. The ECU 2 controls rotation of the rotary actuator 1. The rotary actuator 1 is mounted on, for example, a housing 130 of the shift range switching device 110. The rotary actuator 1 rotates the manual shaft 101 of the shift range switching device 110 thereby to drive a park rod 121 of the parking switching device 120 and the like.

The shift range switching device 110 includes the manual shaft 101, a detent plate 102, a hydraulic pressure valve body 104, the housing 130, and the like. The housing 130 accommodates the manual shaft 101, the detent plate 102, the hydraulic pressure valve body 104, and the like. The manual shaft 101 has one end extending through a cavity 131 (refer to FIG. 1) and protruding out of the housing 130. The cavity 131 is formed in the housing 130.

The manual shaft 101 has one end, which is spline-connected with an output shaft 60 of the rotary actuator 1 ((mentioned later)). The detent plate 102 is formed in a sector shape to extend from the manual shaft 101 outward in the radial direction. The detent plate 102 rotates integrally with the manual shaft 101. The detent plate 102 is equipped with a pin 103. The pin 103 is projected in a direction in parallel with the manual shaft 101.

The pin 103 is retained at an end of a manual spool valve 105. The manual spool valve 105 is equipped to the hydraulic pressure valve body 104. In the present configuration, the detent plate 102 rotates integrally with the manual shaft 101. In addition, the detent plate 102 moves the manual spool valve 105 back and forth in the axial direction. The manual spool valve 105 moves back and forth in the axial direction thereby to switch a hydraulic-pressure-supply channel to the hydraulic pressure clutch of the automatic transmission device 108. Consequently, the operation switches an engagement state of a hydraulic pressure clutch thereby to change a shift range of the automatic transmission device 108.

The detent plate 102 has an end in the radial direction, and the end is equipped with a recessed portion 151, a recessed portion 152, a recessed portion 153, and a recessed portion 154. The recessed portions 151 to 154 correspond to, for example, a P range, an R range, an N range, and a D range, respectively. The P range, the R range, the N range, and the D range are the shift ranges of the automatic transmission device 108. A stopper 107 is supported at a tip end of a blade spring 106. The stopper 107 is engaged with one of the recessed portions 151 to 154 of the detent plate 102, thereby to set the position of the manual spool valve 105 in the axial direction.

On application of a torque of the rotary actuator 1 to the detent plate 102 via the manual shaft 101, the stopper 107 moves to another one of the recessed portions 151 to 154, which is other than and adjacent to the present recessed portion. In this way, the present configuration changes the position of the manual spool valve 105 in the axial direction.

For example, when the manual shaft 101 is rotated in the clockwise rotation viewed in a direction along the arrow Y in FIG. 2, the pin 103 depresses the manual spool valve 105 into the hydraulic pressure valve body 104 via the detent plate 102. In this way, the present configuration switches a hydraulic passage in the hydraulic pressure valve body 104 in order of D, N, R, and P. In this way, the present structure switches the shift range of the automatic transmission device 108 in order of D, N, R, and P.

To the contrary, when the manual shaft 101 is rotated in the counterclockwise rotation, the pin 103 pulls out the manual spool valve 105 from the hydraulic pressure valve body 104. In this way, the present configuration switches the hydraulic passage in the hydraulic pressure valve body 104 in order of P, R, N, and D. In this way, the present structure switches the shift range of the automatic transmission device 108 in order of P, R, N, and D. The manual shaft 101 is rotated by the rotary actuator 1 in this way. A predetermined rotation angle of the manual shaft 101, i.e., a predetermined position of the manual shaft 101 in the rotational direction corresponds to a specific shift range of the automatic transmission device 108.

The parking switching device 120 includes the park rod 121, a park pole 123, a parking gear 126, and the like. The park rod 121 is substantially in an L shape. The park rod 121 has one end connected with the detent plate 102. The park rod 121 has another end equipped with a conical portion 122. The present configuration converts the rotary motion of the detent plate 102 into the linear motion of the park rod 121, thereby to move the conical portion 122 back and forth in the axial direction. The park pole 123 abuts on a lateral side of the conical portion 122. In the present configuration, when the park rod 121 moves back and forth, the park pole 123 rotates about a shaft portion 124.

A projected portion 125 is equipped on the surface of the park pole 123 in the rotational direction. When the projected portion 125 is engaged with the gear of the parking gear 126, rotation of the parking gear 126 is regulated. The present configuration locks a driving wheel via a component such as a drive shaft, a differential gear, and/or the like (not shown). To the contrary, when the projected portion 125 of the park pole 123 is detached from the gear of the parking gear 126, rotation of the parking gear 126 is enabled to release the lock of the driving wheel.

Subsequently, the configuration of the rotary actuator 1 will be described. As shown in FIG. 1, the rotary actuator 1 includes a housing 10, an input axis 20, a motor 3, reduction gears 50, the output shaft 60, a bearing member 91, a seal member 95, and the like. The motor 3 functions as a rotary electric device. The housing 10 includes a front housing 11 and a rear housing 12. The front housing 11 and the rear housing 12 are formed of, for example, resin. The front housing 11 includes a bottomed tubular portion 13 and a support tubular portion 14. The bottomed tubular portion 13 is formed in in a tubular shape having a bottom portion at one end. The support tubular portion 14 is integrally formed with the bottomed tubular portion 13 at a center of the bottom portion of the bottomed tubular portion 13. The rear housing 12 has the bottomed tubular portion 15. The bottomed tubular portion 15 is formed in in a tubular shape having a bottom portion at one end.

The bottomed tubular portion 13 has an opposite end on the opposite side of the bottom portion. The bottomed tubular portion 15 has an opposite end on the opposite of the bottom portion. The front housing 11 and the rear housing 12 are affixed to each other by using bolts in a state where the opposite ends are in contact with each other. In the present structure, the front housing 11 and the rear housing 12 form a space 5 therebetween. The front housing 11 and the rear housing 12 are in contact with each other at a portion at which a gasket 6 is interposed therebetween. The gasket 6 is formed of rubber in an annular shape. The gasket 6 maintains isolation airtightly and liquid-tightly between the inside of the space 5 and the outside of the space 5.

The input axis 20 is formed of, for example metal. The input axis 20 has one end portion 21, a large diameter portion 22, an eccentric portion 23, and the other end portion 24. The one end portion 21, the large diameter portion 22, the eccentric portion 23, and an other end portion 24 are integrally formed with each other and are arranged in this order along the direction of the axis Ax1.

The one end portion 21 is in a columnar shape. The large diameter portion 22 is in a columnar shape and has the outer diameter greater than the outer diameter of the one end portion 21. The large diameter portion 22 is coaxial with the one end portion 21 along the axis Ax1. The eccentric portion 23 is in a columnar shape and has an outer diameter smaller than the outer diameter of the large diameter portion 22. The eccentric portion 23 is eccentric relative to the axis Ax1, which is a rotational center of the input axis 20. That is, the eccentric portion 23 is eccentric relative to both the one end portion 21 and the large diameter portion 22. The other end portion 24 is in a columnar shape and has the outer diameter smaller than the outer diameter of the eccentric portion 23. The other end portion 24 is coaxial with both the one end portion 21 and the large diameter portion 22 along the axis Ax1.

The input axis 20 is rotatably supported at the other end portion 24 by the front bearing 16 and at the one end portion 21 by a rear bearing 17. In present embodiment, the front bearing 16 and the rear bearing 17 are, for example, ball bearings.

The front bearing 16 is equipped inside the output shaft 60 (described later). The output shaft 60 is rotatably supported by a metal bearing 18. The metal bearing 18 is formed of metal in a tubular shape. The metal bearing 18 is equipped inside the front housing 11. Specifically, the other end portion 24 of the input axis 20 is rotatably supported by the metal bearing 18 equipped in the front housing 11, the output shaft 60, and the front bearing 16. The one end portion 21 of the input axis 20 is rotatably supported by the rear housing 12. The rear housing 12 is equipped at the center of the bottom portion of the rear bearing 17. In the present configuration, the input axis 20 is rotatably supported by the housing 10.

The motor 3 functions as a rotary electric device. The motor 3 is a three-phase brushless motor configured to produce driving force without using a permanent magnet. The motor 3 is equipped in the space 5 and located on the side of the rear housing 12. That is, the motor 3 is accommodated in the housing 10. The motor 3 includes a stator 30, a coil 33, a rotor 40, expansive members 80, and the like. The stator 30 is substantially in an annular shape. The stator 30 is press-fitted to a plate 7. The plate 7 is formed of metal and is insert-molded with the rear housing 12. In the present configuration, the plate 7 is fixed to the rear housing 12 such that the plate 7 is unable to rotate.

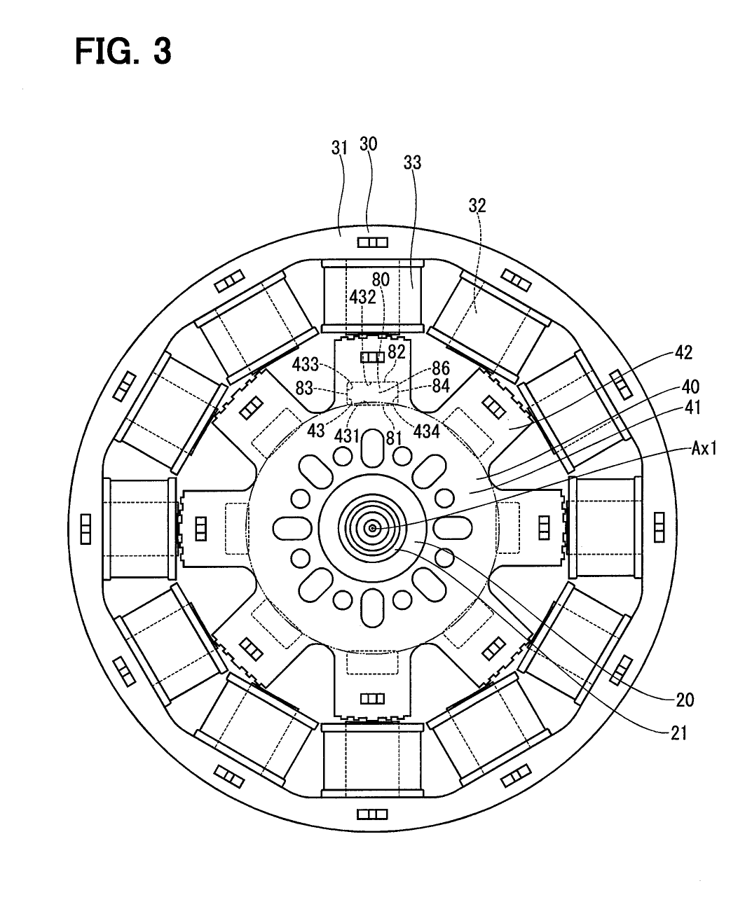

The stator 30 is formed by stacking multiple thin plates in the thickness direction. The thin plates are formed of, for example, a magnetic material such as a ferrous material. The stator 30 includes a stator core 31 and a stator teeth 32. The stator core 31 is in an annular shape. The stator teeth 32 project from the stator core 31 radially inward. The stator teeth 32 include multiple elements arranged at a regular interval in the circumferential direction of the stator core 31. In the present embodiment, the stator teeth 32 include, for example, 12 elements (refer to FIG. 3). It is noted that, in FIG. 3, one reference numeral is denoted on one of the same multiple elements in order to avoid complication in drawings. That is, reference numerals are not denoted to all the same elements, respectively.

The coil 33 is wound around each of the multiple stator teeth 32. The coil 33 is electrically connected to a bus bar potion 70. Referring to FIG. 1, the bus bar potion 70 is equipped to a bottom portion of the bottomed tubular portion 15 of the rear housing 12. The bus bar potion 70 conducts an electric power supplied to the coil 33. The bus bar potion 70 includes terminals 71 connected with the coils 33. The terminals 71 are equipped to the radially inner portions of the coils 33 equipped to the stator 30. The coils 33 is electrically connected to the terminals 71. The terminals 71 are supplied with an electric power according to a driving signal sent from the ECU 2.

The rotor 40 is equipped on the radially inner side of the stator 30. The rotor 40 is formed by stacking multiple thin plates in the thickness direction. The thin plates are formed of, for example, a magnetic material (soft magnetic material) such as a ferrous material. Herein, a thermal expansion coefficient of the rotor 40 is about 12.1×(10⁻⁶/° C.). The rotor 40 includes a rotor core 41, salient poles 42, and accommodation cavity portions 43.

The rotor core 41 is in an annular shape and is press-fitted to the large diameter portion 22 of the input axis 20. The salient poles 42 project from the rotor core 41 radially outward to the outer stator 30. The salient poles 42 include multiple elements arranged at a regular interval in the circumferential direction of the rotor core 41. In the present embodiment, the salient poles 42 include, for example, 8 elements (refer to FIG. 3). In FIG. 3, a two-point chain line shows a boundary between the rotor core 41 and the salient pole 42.

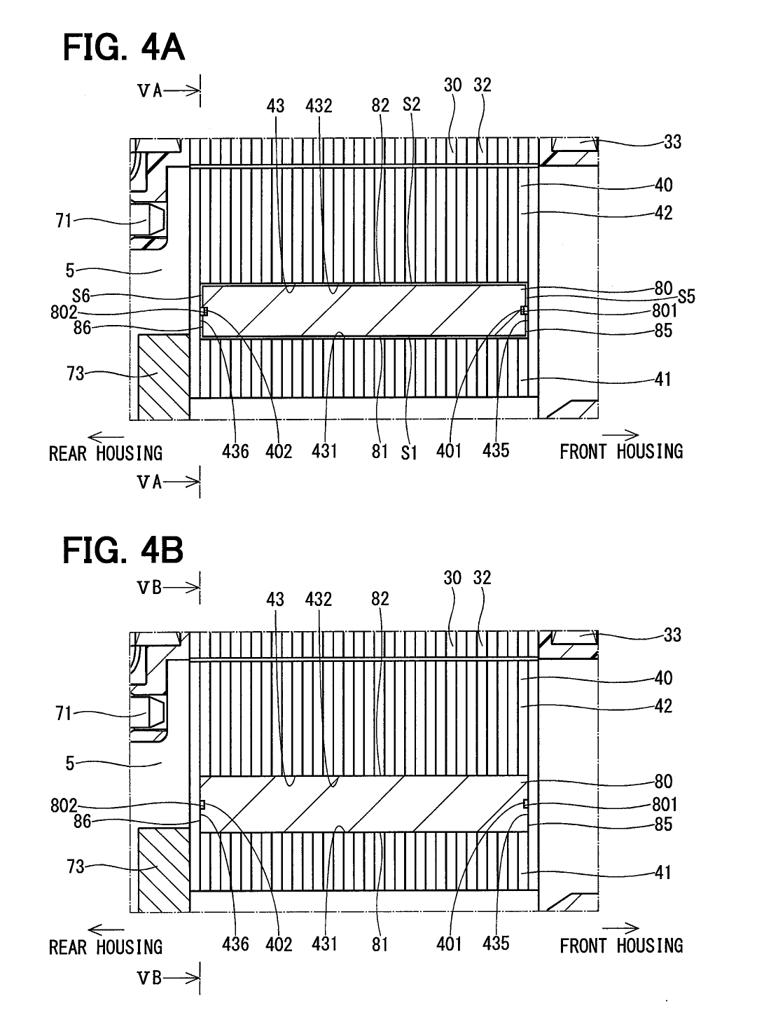

The accommodation cavity portions 43 are formed in at least the salient poles 42 among the rotor core 41 and the salient poles 42 (refer to FIGS. 3 and 4). The accommodation cavity portions 43 extend in the thickness direction. As shown in

FIG. 3, the accommodation cavity portions 43 are formed in the eight elements of the salient poles 42, respectively. That is, eight elements of the accommodation cavity portions 43 are formed similarly to the salient poles 42. The accommodation cavity portions 43 are formed around the boundary between the rotor core 41 and the salient pole 42. Measure portions of the accommodation cavity portions 43 are formed in the salient poles 42, and remainders are formed in the rotor core 41. As shown in FIGS. 3, 4, an 5, the accommodation cavity portions 43 include inner walls 431, 432, 433, 434, 435, and 436.

The inner wall 431 is located on the side of the axis Ax1 of the input axis 20 relative to the center of the accommodation cavity portion 43. The inner wall 431 is in a planar form and is in a rectangular shape. The inner wall 431 is in parallel with the axis Ax1. The inner wall 432 is located on the opposite side of the center of the accommodation cavity portion 43 from the axis Ax1, such that the inner wall 432 is opposed to the inner wall 431. The inner wall 432 is in a planar form and is in a rectangular shape. The inner wall 431 and the inner wall 432 are in parallel with each other.

The inner wall 433 is located between an outer peripheral end of the inner wall 431 and an outer peripheral end of the inner wall 432. The inner wall 433 is in a planar form and is in a rectangular shape. The inner wall 434 is located between an outer peripheral end of the inner wall 431 and an outer peripheral end of the inner wall 432, such that the inner wall 434 is opposed to the inner wall 433. The inner wall 434 is in a planar form and is in a rectangular shape. The inner wall 433 and the inner wall 434 are in parallel with each other.

The inner wall 435 is located on the side of the front housing 11 relative to the center of the accommodation cavity portion 43. The inner wall 435 is in a planar form and is in a rectangular shape. Referring to FIGS. 4A and 4B, the inner wall 435 is formed on the surface of one of the thin plates of the rotor 40. The surface of one of the thin plates is located on the side of the rear housing 12. The one of the thin plates is closest to the front housing 11.

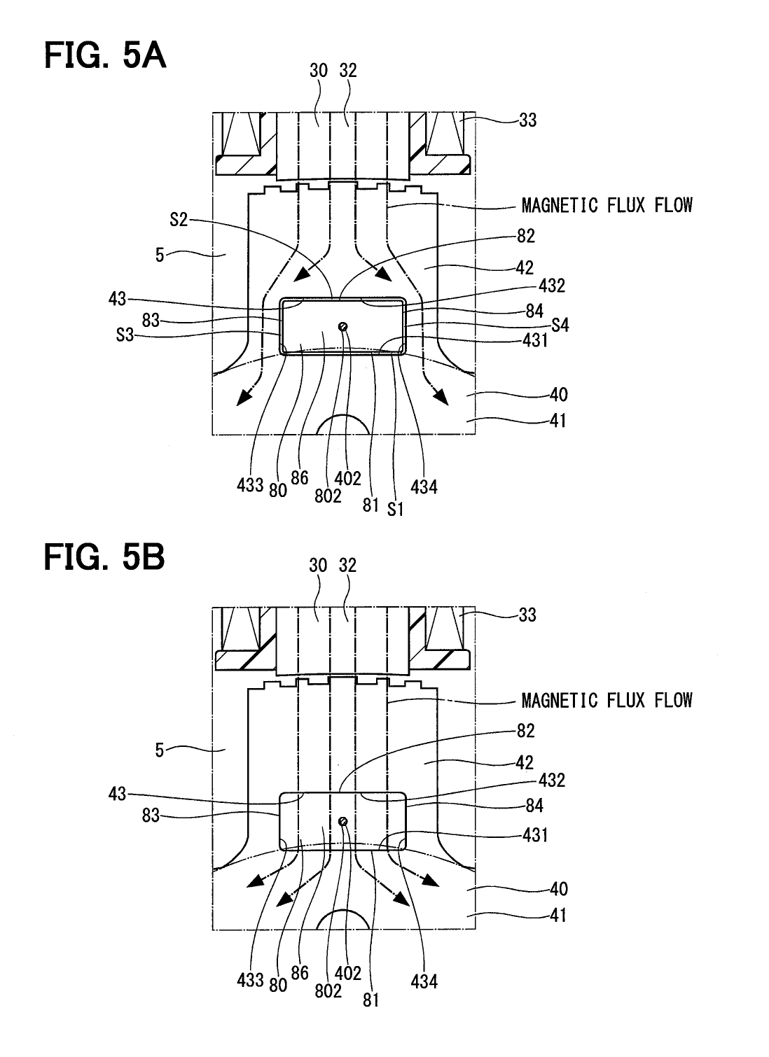

The inner wall 436 is located on the side of the rear housing 12 relative to the center of the accommodation cavity portion 43. The inner wall 436 is opposed to the inner wall 435. The outer peripheral ends of the inner wall 436 are connected with the outer peripheral ends of the inner walls 431 to 434. The inner wall 436 is in a planar form and is in a rectangular shape. Referring to FIGS. 4A and 4B, the inner wall 436 is formed on the surface of one of the thin plates of the rotor 40. The surface of one of the thin plates is located on the side of the front housing 11. The one of the thin plates is closest to the rear housing 12. The inner wall 435 and the inner wall 436 are in parallel with each other. In the above-described structure, the inner walls 431 to 436 form the accommodation cavity portion 43 in a rectangular parallelepiped shape. As shown in FIGS. 5A and 5B, in the present embodiment, each of a corner portion between the inner wall 431 and the inner wall 433, a corner portion between the inner wall 433 and the inner wall 432, a corner portion between the inner wall 432 and the inner wall 434, and a corner portion between the inner wall 434 and the inner wall 431 has a curved surface. Referring to FIGS. 4A and 4B, a projected portion 401 is formed at a center of the inner wall 435. The projected portion 401 is projected toward the inner wall 436. In addition, a projected portion 402 is formed at a center of the inner wall 436. The projected portion 402 is projected toward the inner wall 435. The rotor core 41 is press-fitted to the input axis 20 thereby to enable the rotor 40 to rotate relatively to the housing 10 and the stator 30.

Each of the expansive members 80 is formed of a magnetic material (soft magnetism material) such as permalloy. More specifically, the expansive member 80 is formed of a material, which is produced by adding an additive such as Mo and/or Cu to 78-permalloy, which is Ni—Fe alloy containing Ni by 78%, thereby to enhance its magnetic permeability. The expansive member 80 may be formed of permalloy C defined by JIS standard. The expansive member 80 formed of the material has a relatively high magnetic permeability. Herein, a thermal expansion coefficient of the expansive member 80 is about 13.6×(10⁻⁶/° C.). That is, the thermal expansion coefficient of the expansive member 80 is greater than the thermal expansion coefficient of the rotor 40. The expansive member 80 is equipped inside the accommodation cavity portion 43 formed in the rotor 40. The number of the expansive members 80 is the same as the number of the accommodation cavity portions 43. Specifically, the expansive members 80 include eight elements correspondingly to the number of the accommodation cavity portion 43. Each of the expansive members 80 is in a rectangular parallelepiped shape correspondingly to the shape of the accommodation cavity portion 43. As shown in FIGS. 3 to 5B, the expansive member 80 has a front surface 81, a rear surface 82, lateral surfaces 83 and 84, an upper surface 85, and a lower surface 86.

The front surface 81 forms an outer wall opposed to the inner wall 431 of the accommodation cavity portion 43. The front surface 81 is in a planar form and is in a rectangular shape. The rear surface 82 forms an outer wall opposed to the inner wall 432 of the accommodation cavity portion 43. The rear surface 82 is in a planar form and is in a rectangular shape. The front surface 81 and the rear surface 82 are in parallel with each other.

The lateral surface 83 forms an outer wall opposed to the inner wall 433 of the accommodation cavity portion 43. The lateral surface 83 is in a planar form and is in a rectangular shape. The lateral surface 84 forms an outer wall opposed to the inner wall 434 of the accommodation cavity portion 43. The lateral surface 84 is in a planar form and is in a rectangular shape. The lateral surface 83 and the lateral surface 84 are in parallel with each other.

The upper surface 85 forms an outer wall opposed to the inner wall 435 of the accommodation cavity portion 43. The upper surface 85 is in a planar form and is in a rectangular shape. The lower surface 86 forms an outer wall opposed to the inner wall 436 of the accommodation cavity portion 43. The lower surface 86 is in a planar form and is in a rectangular shape. The upper surface 85 and the lower surface 86 are in parallel with each other. As shown in FIGS. 5A and 5B, in the present embodiment, each of a corner portion between the front surface 81 and the lateral surface 83, a corner portion between the lateral surface 83 and the rear surface 82, a corner portion between the rear surface 82 and the lateral surface 84, and a corner portion between the lateral surface 84 and the front surface 81 has a curved surface.

Referring to FIGS. 4A and 4B, a recessed portion 801 is formed at a center of the upper surface 85. The recessed portion 801 is recessed toward the lower surface 86. In addition, a recessed portion 802 is formed at a center of the lower surface 86. The recessed portion 802 is recessed toward the upper surface 85. The expansive member 80 is equipped in the accommodation cavity portion 43 in the state where the projected portion 401 extends into the recessed portion 801, and the projected portion 402 extends into the recessed portion 802. In the present configuration, the position of the expansive member 80 is stabilized in the accommodation cavity portion 43. The expansive member 80 and the rotor 40 expand when, for example, its temperature increases due to increase in the environmental temperature.

According to the present embodiment, when the environmental temperature is below a predetermined temperature, that is, when the temperature of the expansive member 80 and the rotor 40 is below the predetermined temperature, the outer wall of the expansive member 80 and the inner wall of the accommodation cavity portion 43 form a gap therebetween. As shown in FIGS. 4A and 5A, for example, a gap S1 is formed between the front surface 81 and the inner wall 431, a gap S2 is formed between the rear surface 82 and the inner wall 432, a gap S3 is formed between the lateral surface 83 and the inner wall 433, a gap S4 is formed between the lateral surface 84 and the inner wall 434, a gap S5 is formed between the upper surface 85 and the inner wall 435, and a gap S6 is formed between the lower surface 86 and the inner wall 436. In the present state where the temperature of the expansive member 80 and the rotor 40 is below predetermined temperature, an air gap is formed between the outer wall of the expansive member 80 and the inner wall of the accommodation cavity portion 43. In the present state, the projected portion 401 extends into the recessed portion 801, and the projected portion 402 extends into the recessed portion 802.

To the contrary, when the environmental temperature is higher than the predetermined temperature, that is, when the temperature of the expansive member 80 and the rotor 40 is higher than the predetermined temperature, the outer wall of the expansive member 80 and the inner wall of the accommodation cavity portion 43 at least partially make contact with each other. As shown in FIGS. 4B and 5B, according to the present embodiment, the front surface 81 and the inner wall 431 make contact with each other, the rear surface 82 and the inner wall 432 make contact with each other, the lateral surface 83 and the inner wall 433 make contact with each other, the lateral surface 84 and the inner wall 434 make contact with each other, the upper surface 85 and the inner wall 435 make contact with each other, and the lower surface 86 and the inner wall 436 make contact with each other. According to the present embodiment, the predetermined temperature is set at, for example, about 0 degree Celsius.

When an electric power is supplied to the coil 33, a magnetic flux occurs in the stator teeth 32 around which the coil 33 is wound. The magnetic flux occurring in the stator teeth 32 flows through the salient poles 42 of the rotor 40 into the rotor core 41. The magnetic flux flowing through the salient poles 42 into the rotor core 41 further flows through the salient poles 42 into the stator teeth 32. The magnetic flux causes the stator teeth 32 to attract the corresponding salient pole 42 of the rotor 40. The multiple coils 33 are assigned with, for example, three phases including a U-phase, a V-phase, and a W-phase, respectively. When the ECU 2 switches the electricity supply in order of the U-phase, the V-phase, and the W-phase, the rotor 40 rotates in, for example, one circumferential direction. Contrary, when the ECU 2 switches the electricity supply in order of the W-phase, the V-phase, and the U-phase, the rotor 40 rotates in, for example, the other circumferential direction. The ECU 2 switches electricity supply to the coils 33 in this way, thereby to control the magnetic force caused in the stator teeth 32. In the present configuration, the ECU 2 enables the rotor 40 to rotate in a desirable direction.

Referring to FIG. 5A, for example, when the temperature of the expansive member 80 and the rotor 40 is below the predetermined temperature, the gaps S1 to S6, i.e., air gaps are formed between the outer walls of the expansive member 80 and the inner walls of the accommodation cavity portion 43. Therefore, when electric power is supplied to the coil 33 to cause the magnetic flux in the stator teeth 32, the magnetic flux flows through the salient poles 42 and the rotor core 41 to circumvent (avoid) the expansive member 80 and the gaps S1 to S6. That is, in the present state, the rotor 40 is in a magnetic saturation state, in which the rotor 40 hardly conducts the magnetic flux, due to the gaps S1 to S6.

To the contrary, as shown in FIG. 5B, when the temperature of the expansive member 80 and the rotor 40 is higher than the predetermined temperature, the outer walls of the expansive member 80 and the inner walls of the accommodation cavity portion 43 make contact with each other, respectively, thereby to eliminate the air gaps therebetween. Therefore, when an electric power is supplied to the coil 33 to cause the magnetic flux in the stator teeth 32, the magnetic flux flows through the salient poles 42, the expansive member 80, and the rotor core 41, without circumventing the expansive member 80. In the present state, the rotor 40 is in a state to easily conduct the magnetic flux therethrough.

In the present embodiment, a rotary encoder 72 is equipped between the bottom portion of the bottomed tubular portion 15 of the rear housing 12 and the rotor core 41. The rotary encoder 72 includes a magnet 73, a circuit board 74, a hall IC device 75, and the like.

The magnet 73 in an annular shape is a multi-pole magnets having an N pole and an S pole alternately magnetized in the circumferential direction. The magnet 73 is coaxial with the rotor core 41 and is located at an end of the rotor core 41 on the side of the rear housing 12. The circuit board 74 is affixed to an inner wall of the bottom portion of the bottomed tubular portion 15 of the rear housing 12. The hall IC device 75 is mounted on the circuit board 74 and is opposed to the magnet 73.

The hall IC device 75 includes a hall element and a signal conversion circuit. The hall element is a magnetoelectric conversion element configured to implement magnetoelectric conversion by utilizing the Hall effect. The hall element sends an electric signal proportional to a density of a magnetic flux, which is sent from the magnet 73. The signal conversion circuit converts the output signal of the hall element into a digital signal. The hall IC device 75 sends a pulse signal through a signal pin 76 to the ECU 2. The pulse signal is synchronized with rotation of the rotor core 41. The ECU 2 is configured to detect the rotation angle and the rotational direction of the rotor core 41 according to the pulse signal sent from the hall IC device 75. The reduction gears 50 include a ring gear 51 and a sun gear 52.

The ring gear 51 is in an annular shape. The ring gear 51 is formed of, for example, a metallic material, such as a ferrous material. An annular plate 8 is insertion-molded with the middle housing 10. The ring gear 51 is press-fitted to the annular plate 8 thereby to be incapable of rotating relative to the housing 10. Herein, the ring gear 51 is affixed to the housing 10 such that the ring gear 51 is coaxial with the input axis 20 (axis Ax1). The ring gear 51 has inner teeth 53 formed on its inner circumferential periphery.

The sun gear 52 is substantially in a disc shape. The sun gear 52 is formed of, for example, a metallic material, such as a ferrous material. The sun gear 52 includes projected portions 54 each being in a column shape. Each of the projected portions 54 is projected in the thickness direction from a position, which is at a predetermined distance from the center of one surface of the sun gear 52 in the radial direction. The projected portions 54 are arranged in the circumferential direction of the sun gear 52 at a regular interval. The sun gear 52 has outer teeth 55 formed on its outer circumferential periphery, such that the outer teeth 55 are enabled to mesh with the inner teeth 53 of the ring gear 51. A middle bearing 19 is equipped on the outer circumferential periphery of the eccentric portion 23 of the input axis 20. The sun gear 52 is equipped eccentrically relative to the input axis 20 via the middle bearing 19 such that the sun gear 52 is enabled to rotate relative to the input axis 20. In the present configuration, when the input axis 20 rotates, the sun gear 52 revolves and rotates inside the ring gear 51, while the outer teeth 55 is meshed with the inner teeth 53 of the ring gear 51. Herein, the middle bearing 19 is, for example, a ball bearing similarly to the front bearing 16 and the rear bearing 17.

The output shaft 60 is formed of, for example, a metallic material, such as a ferrous material. The output shaft 60 includes an output tubular portion 61 and a disc portion 62. The output tubular portion 61 is substantially in a tubular shape. The disc portion 62 is substantially in a disc shape. The metal bearing 18 is equipped inside the support tubular portion 14 of the front housing 11. The output tubular portion 61 is rotatably supported by the support tubular portion 14 of the housing 10 via the metal bearing 18. Herein, the output tubular portion 61 is coaxial with the large diameter portion 22 of the input axis 20. A front bearing 16 is equipped inside the output tubular portion 61. In the present configuration, the output tubular portion 61 rotatably supports the other end portion 24 of the input axis 20 via the metal bearing 18 and the front bearing 16. The output tubular portion 61 has spline grooves 64 at the inner circumferential periphery.

The disc portion 62 is located in the space 5. The disc portion 62 is substantially in a disc shape to extend radially outward from the end of the output tubular portion 61 on the side of the sun gear 52. The disc portion 62 has hole portions 63. The projected portions 54 of the sun gear 52 are enabled to enter the hole portions 63, respectively. The hole portions 63 are formed to extend through the disc portion 62 in the thickness direction. The number of the hole portions 63 is the same as the number of the projected portions 54. The hole portions 63 are arranged in the circumferential direction of the disc portion 62 correspondingly to the projected portions 54. Referring to FIG. 3, the outer circumferential periphery of the disc portion 62 is formed with outer teeth 55 entirely in the circumferential direction.

In the above-described configuration, when the sun gear 52 revolves and rotates inside the ring gear 51, the outer walls of the projected portions 54 applies force onto the inner walls of the hole portions 63 of the disc portion 62 of the output shaft 60, respectively, in the circumferential direction of the disc portion 62. The present configuration transmits a rotation component of the sun gear 52 to the output shaft 60. The rotational speed of the sun gear 52 is lower than the rotational speed of the input axis 20. In the present configuration, the rotation output of the motor 3 is reduced in speed and outputted from the output shaft 60. In this way, the ring gear 51 and the sun gear 52 function as reduction gears.

Referring to FIG. 1, one end of the manual shaft 101 of the shift-by-wire system 100 is fitted to the spline groove 64 of the output shaft 60, such that the output shaft 60 and the manual shaft 101 are in spline connection with each other. In the present configuration, rotation of the input axis 20 is transmitted through the reduction gears 50 to the output shaft 60. The output shaft 60 outputs a torque of the motor 3 to the manual shaft 101.

The bearing member 91 is supported inside the support tubular portion 14. Specifically, the bearing member 91 is fitted into a stationary member 92. The stationary member 92 is formed of a metallic material into a tubular shape. The stationary member 92 is insert-molded with an inner portion of the support tubular portion 14. In the present embodiment, the bearing member 91 is a ball bearing similarly to the front bearing 16, the rear bearing 17, and the middle bearing 19. As shown in FIG. 1, the rotary actuator 1 is mounted to the housing 130 of the shift range switching device 110, such that an end of the manual shaft 101 is connected to the inside of the output tubular portion 61 of the output shaft 60.

Specifically, the rotary actuator 1 has an end, which is connected with the output shaft 60 of the manual shaft 101, and the end is formed with a small diameter portion 111. The small diameter portion 111 has the outer diameter smaller than the outer diameter of other portions of the manual shaft 101. The small diameter portion 111 has an end on the opposite side of the output shaft 60, and the end is formed with a tapered portion 112. In the present embodiment, the small diameter portion 111 and the tapered portion 112 are located outside the housing 130. The inner diameter of the bearing member 91 is substantially the same as the outer diameter of the small diameter portion 111. The small diameter portion 111 has an end on the opposite side of the tapered portion 112. That is, this end of the small diameter portion 111 is one end of the manual shaft 101. The outer wall of this end of the small diameter portion 111 is formed with a spline groove 113.

When the rotary actuator 1 is mounted to the housing 130, the spline groove 64 of the output tubular portion 61 of the output shaft 60 and the spline groove 113 of the manual shaft 101 are fitted to each other. In this way, spline connection is made between the output shaft 60 and the manual shaft 101. In the present condition, the bearing member 91 rotationally supports the small diameter portion 111 of the manual shaft 101.

The seal member 95 is formed of, for example, resin, such as acrylic resin, or heat-resistant water resistance rubber in an annular shape. The seal member 95 is equipped inside the support tubular portion 14 of the front housing 11. The seal member 95 has the outer diameter, which is substantially the same as the inner diameter of the support tubular portion 14. The seal member 95 has the inner diameter, which is substantially the same as the outer diameter of the small diameter portion 111 of the manual shaft 101. The seal member 95 is configured to maintain airtightness and/or liquid-tightness between the outer wall of the small diameter portion 111 of the manual shaft 101 and the inner wall of the support tubular portion 14, in a state where the manual shaft 101 is joined with the output tubular portion 61 of the output shaft 60.

(1) As described above, the motor 3 according to the present embodiment includes the housing 10, the stator 30, the coil 33, the rotor 40, and the expansive member 80. The stator 30 is equipped inside the housing 10. The coil 33 is equipped to the stator 30 and is configured to produce a magnetic flux when supplied with an electricity.

The rotor 40 is formed of a magnetic material. The rotor 40 is rotational inside the stator 30. The rotor 40 includes the rotor core 41 and the salient poles 42. The salient poles 42 are projected from the rotor core 41 toward the stator 30. The rotor 40 has accommodation cavity portions 43. The accommodation cavity portions 43 are formed to extend in the thickness direction in at least the salient poles 42 among the rotor core 41 and the salient pole 42. The expansive member 80 is formed of a magnetic material having the thermal expansion coefficient, which is different from the thermal expansion coefficient of the rotor 40. The expansive member 80 is equipped inside the accommodation cavity portion 43 and is configured to expand as the temperature increases.

In the present embodiment, for example, when the environmental temperature is below the predetermined temperature, the outer walls of the expansive member 80 and the inner walls of the accommodation cavity portion 43 form the gaps S1 to S6 therebetween. In the present state, the resistance of the coil 33 decreases, and the magnetic flux produced from the coils 33 increases. To the contrary, the configuration renders the magnetic flux produced from the coil 33 to hardly flow through the rotor 40 due to the formation of the gaps. Thus, the present configuration enables to restrict the output torque of the motor 3 from excessively increasing under a low temperature condition.

To the contrary, when the environmental temperature is higher than the predetermined temperature, at least a part of the outer walls of the expansive member 80 and the inner walls of the accommodation cavity portion 43 make contact with each other. In the present state, the resistance of the coil 33 increases, and the magnetic flux produced from the coils 33 decreases. To the contrary, the configuration in the present state facilitates the magnetic flux produced from the coil 33 to easily flow through the rotor 40 due to the elimination of the gaps. Thus, the present configuration enables to restrict the output torque of the motor 3 from excessively decreasing under a high temperature condition. In this way, the present configuration according to the present embodiment causes each of the expansive members 80 inside the accommodation cavity portion 43 to expand in response to increase in temperature. The present configuration enables to stabilize the output torque of the motor 3, i.e., to reduce variation in the output torque of the motor 3, irrespective of the environmental temperature.

(2) In addition, the present configuration according to the present embodiment forms the gaps S1 to S6 between at least a part of the outer walls of the expansive member 80 and the inner walls of the accommodation cavity portion 43 when the environmental temperature is below the predetermined temperature. To the contrary, when the environmental temperature is higher than the predetermined temperature, at least a part of the outer walls of the expansive member 80 and the inner walls of the accommodation cavity portion 43 make contact with each other. Therefore, the present configuration enables to stabilize the output torque of the motor 3 irrespective of the environmental temperature, as described above.

(3) In addition, according to the present embodiment, the expansive member 80 is formed of a soft magnetism material. That is, the expansive member 80 has a large magnetic permeability and has a small holding property. Therefore, when the outer walls of the expansive member 80 and the inner walls of the accommodation cavity portion 43 make contact with each other in response to increase in the temperature, the configuration facilitates the magnetic flux to flow through the expansive member 80. In addition, even in the configuration to conduct the magnetic flux through the expansive member 80, the magnetic force, which remains in the expansive member 80, reduces when the magnetic flux disappears. Therefore, the present configuration enables to stabilize the output torque of the motor 3 irrespective of the environmental temperature and to restrict the magnetic force, which remains to the expansive member 80, from exerting effect on the rotational motion of the rotor 40.

(4) In addition, the shift-by-wire system 100 according to the present embodiment includes the rotary actuator 1, which includes the above-described motor 3, and the shift range switching device 110. The shift range switching device 110 is connected to the output shaft 60 of the rotary actuator 1 and is configured to switch the shift range of the automatic transmission device 108 by utilizing the torque outputted from the motor 3 and transmitted through the output shaft 60.

The motor 3 according to the present embodiment is configured to stabilize the output torque irrespective of the environmental temperature. Therefore, the rotary actuator 1 is configured to steadily switch the shift range of the automatic transmission device 108 irrespective of the environmental temperature. In consideration of that, the motor 3 according to the present embodiment may be applicable to, for example, the shift-by-wire system 100 used under a wide temperature range between, for example, −40 degree Celsius to 100 degree Celsius.

(Other embodiment)

The above-described embodiment exemplifies the configuration where, when the environmental temperature is below the predetermined temperature, all the six outer walls of the expansive member and all the six inner walls of the accommodation cavity portion form the gaps (S1, S2, S3, S4, S5, S6) therebetween. In addition, in the configuration of the embodiment, when the environmental temperature is higher than the predetermined temperature, all the six outer walls of the expansive member and all the six inner walls of the accommodation cavity portion make contact with each other. It is noted that, according to another embodiment of the present disclosure, when the environmental temperature is below the predetermined temperature, the outer walls of the expansive member and the inner walls of the accommodation cavity portion may form a gap at least partially therebetween. In addition, in the other embodiment, when the environmental temperature is higher than the predetermined temperature, the outer walls of the expansive member and the inner walls of the accommodation cavity portion may at least partially make contact with each other.

In the above embodiment, the predetermined temperature is substantially set at 0 degree Celsius. To the contrary, according to another embodiment of the present disclosure, the predetermined temperature may be set at a temperature below 0 degree Celsius. The predetermined temperature may be set at a temperature higher than 0 degree Celsius. The predetermined temperature may be set at a temperature, which is lower than an ambient temperature such as 15 degree Celsius. The above-described embodiment exemplifies the configuration where the accommodation cavity portion is formed at the position close to the boundary between the salient pole and the rotor core. To the contrary, according to another embodiment of the present disclosure, the accommodation cavity portion may be formed at a position close to a tip end of the salient pole. The accommodation cavity portion and the expansive member may be located on the side of the stator, i.e., may be located in the stator. In this case, the accommodation cavity portion and the expansive member may be located at a position to enable to regulate the flow of the magnetic flux.

The above-described embodiment exemplifies each of the accommodation cavity portion and the expansive member in a rectangular parallelepiped shape. It is noted that, the accommodation cavity portion and the expansive member are not limited to be in rectangular parallelepiped shapes. According to another embodiment of the present disclosure, the accommodation cavity portion and/or the expansive member may be employ various forms. In this case, the accommodation cavity portion and the expansive member may be in shapes corresponding to each other, i.e., may be in similar shapes and/or may be in homologous shapes, respectively. According to another embodiment of the present disclosure, the projected portions 401 and 402 need not be formed in the accommodation cavity portion. The recessed portions 801 and 802 need not be formed in the expansive member.

The above embodiment exemplifies the expansive member formed of permalloy C. It is noted that, according to another embodiment of the present disclosure, the expansive member may be formed of, for example, 45-permalloy, which is a Ni—Fe alloy containing about 45% of nickel, and is defined as the permalloy B in the JIS standard. In this case employing 45-permalloy, the thermal expansion coefficient of the expansive member is about 7.7×(10⁻⁶/° C.). That is, in this case, the thermal expansion coefficient of the expansive member is smaller than the thermal expansion coefficient of the rotor. The present configuration is also configured to form a gap between the outer wall of the expansive member and the inner wall of the accommodation cavity portion of the rotor according to the temperature, i.e., in response to variation in the temperature. Therefore, similarly to the above-described embodiment, the present configuration also enables to stabilize the output torque of the rotary electric device irrespective of the environmental temperature.

It is noted that, the material of the expansive member 80 is not limited to permalloy. According to another embodiment of the present disclosure, the expansive member 80 may be formed of various kinds of a soft magnetism material such as silicon steel, sendust, permendur, soft ferrite, amorphous magnetism alloy, nano-crystal magnetism alloy, or the like.

The above-described embodiment exemplifies a configuration employing the reduction gears configured to reduce the rotational speed of the input axis and thereafter to transmit the rotational movement reduced in speed to the output shaft. It is noted that, according to the another embodiment of the present disclosure, in replace of the reduction gears, speed increasing gears may be employed to increase the rotational speed of the input axis and to transmit the rotational movement increased in speed to the output shaft. Alternatively, a configuration may be employable to include, in place of the reduction gears, a mechanism to transmit the rotational movement of the input axis at the constant speed to the output shaft. Alternatively, a configuration may be employable to connect or to form the input axis and the output axis to be incapable to rotate relatively to each other, without the reduction gears and/or the speed increasing gears. The disclosure may employ various configurations to enable the output shaft to receive transmission of the rotational movement of the input shaft and to output the torque of the rotary electric device to the shaft being the driven object.

The above-described embodiment exemplifies the configuration in which the rotary actuator including the rotary electric device is mounted to the housing of the shift range switching device. It is noted that, according to another embodiment of the present disclosure, the rotary actuator may be mounted to an object such as a portion of a shift range switching device other than the housing and/or an object being an outer wall of a device. It is noted that, the rotary electric device is not limited to a three-phase brushless motor. According to another embodiment of the present disclosure, the rotary electric device may be a motor in a form other than a three-phase brushless motor. The rotary electric device may be a power generator configured to generate an electric power on receiving an inputting torque.

It is noted that, the number of the recessed portions in the detent plate is not limited to four. According to another embodiment of the present disclosure, the number of the recessed portions in the detent plate may be employable from various numbers. That is, the present disclosure may be in practice with a detent plate having recessed portions, the number of which is other than four. The shift-by-wire system of the above-described embodiment according to the present disclosure may be employable to various apparatuses such as a continuously variable transmission (CVT) mechanism, an automatic transmission (NT) mechanism for a hybrid vehicle (HV), and/or a parking mechanism for an HV or an electric vehicle (EV). The continuously variable transmission (CVT) mechanism is, for example, switchable among four positions of a P range, a R range, an N range, and a D position. The parking mechanism for an HV or an electric vehicle (EV) is, for example, switchable between a P position and a not-P position. According to another embodiment of the present disclosure, the rotary actuator including the rotary electric device may be employable for various mechanisms, as driven objects, other than the shift range switching device of a shift-by-wire system of a vehicle, a parking switching device, or the like.

As described above, the rotary electric device according to the present disclosure includes the housing, the stator, the coil, the rotor, and the expansive member.

The stator is equipped in the housing. The coil is equipped in the stator and is configured to produce a magnetic flux when supplied with an electricity. The rotor is formed of a magnetic material. The rotor is rotatably equipped in the stator. The rotor includes a rotor core, a salient pole, and an accommodation cavity portion. The salient pole is projected from the rotor core toward the stator. The accommodation cavity portion extends in at least the salient pole among the rotor core and the salient pole in a thickness direction. That is, the accommodation cavity portion extends in a portion of the rotor. The portion of the rotor includes at least the salient pole. The portion of the rotor may include both the rotor core and the salient pole. The expansive member is formed of the magnetic material having the thermal expansion coefficient, which is different, i.e., distinct from the thermal expansion coefficient of the rotor. The expansive member is equipped in the accommodation cavity portion. The expansive member is configured to expand in response to increase in the temperature.

According to the present disclosure, when, for example, the environmental temperature is below the predetermined temperature, the outer wall of the expansive member and the inner wall of the accommodation cavity portion form the gap therebetween. In the present configuration in the present state, the resistance of the coil becomes smaller due to increase in the temperature thereby to facilitate the magnetic flux from the coil to flow through the coil. At the same time, the magnetic flux produced from the coil becomes hard to flow through the rotor due to the formation of the gap. That is, reduction in the resistance of the coil and the formation of the gap may offset to each other to render the magnetic flux flow substantially constant. The present configuration enables to restrict the output torque, which is outputted from the rotary electric device, from increasing excessively under the low temperature state.

To the contrary, when the environmental temperature is higher than the predetermined temperature, the outer wall of the expansive member and the inner wall of the accommodation cavity portion at least partially make contact with each other. In the present state, the resistance of the coil becomes larger thereby to decrease the magnetic flux from the coil. At the same time, the present configuration facilitates the magnetic flux from the coil to flow through the rotor. Therefore, the present configuration enables to restrict excessive reduction in the output torque of the rotary electric device under a high-temperature state. The present configuration according to the present disclosure enables the expansive member to expand in the accommodation cavity portion in response to increase in the temperature. Thus, the present configuration enables to stabilize the output torque of the rotary electric device irrespective of the environmental temperature.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A rotary electric device comprising:
a housing;
a stator equipped in the housing;
a coil equipped to the stator and configured to produce a magnetic flux when supplied with an electricity;
a rotor formed of a magnetic material and rotational in the stator, the rotor including a rotor core, a salient pole, and an accommodation cavity portion, the salient pole projected from the rotor core toward the stator, the accommodation cavity portion extending in the salient pole along a thickness direction; and
an expansive member formed of a magnetic material, which has a thermal expansion coefficient different from a thermal expansion coefficient of the rotor, wherein
the expansive member is equipped in the accommodation cavity portion, and
the expansive member is configured to expand in response to increase in a temperature.

2. The rotary electric device according to claim 1, wherein
an outer wall of the expansive member and an inner wall of the accommodation cavity portion at least partially form a gap therebetween under a temperature below a predetermined temperature, and
the outer wall of the expansive member and the inner wall of the accommodation cavity portion at least partially make contact with each other under a temperature higher than the predetermined temperature.

3. The rotary electric device according to claim 1, wherein
the expansive member is formed of a soft magnetism material.

4. The rotary electric device according to claim 1, wherein
the accommodation cavity portion extends in both the rotor core and the salient pole along the thickness direction.

5. A shift-by-wire system comprising:
the rotary electric device according to claim 1; and
a shift range switching device configured to switch a shift range of an automatic transmission device in response to a torque from the rotary electric device.
